(19) United States
(12) Patent Application Publication
(10) Pub. No.: US 2009/0151748 A1
(43) Pub. Date: Jun. 18, 2009

(54) Facial blotter with improved oil absorbency

(76) Inventor: Aneshia D. Ridenhour, Canton, GA (US)

Correspondence Address: KIMBERLY-CLARK WORLDWIDE, INC.;Catherine E. Wolf, 401 NORTH LAKE STREET, NEENAH, WI, 54956, US

(21) Appl. No.: 12/215,946

(22) Filed: Jun. 30, 2008

Related U.S. Application Data
(63) Continuation-in-part of application No. 11/955,714, filed on Dec. 13, 2007.

(51) Int. Cl. B08B 7/00; B32B 9/00

(52) U.S. Cl. 134/6; 428/220

(57) ABSTRACT

A laminated oil absorbing wipe comprises a non-pigmented thermoplastic nonwoven substrate layer and a pigmented thermoplastic nonwoven substrate layer where the wipe has a bulk of between 0.2 mm and 1.0 mm, where at least a portion of the non-pigmented layer is configured to undergo a change in opacity upon the absorption of a bodily oil so that the portion is at least partially translucent or transparent to light and the color of the pigmented layer becomes visible through the partially translucent or transparent portion, and where the wipe has an oil absorption capacity of at least about 1 g/g as measured by the Oil Absorbency Test.

This application is a continuation-in-part of application Ser. No. 11/955,714 entitled Cosmetic Wipe that Provides a Visual Indication of its Effectiveness and filed in the U.S. Patent and Trademark Office on Dec. 13, 2007. The entirety of application Ser. No. 11/955,714 is hereby incorporated by reference.

### BACKGROUND

Many consumers experience more than desired oil and sebum on their face, such as from oily sebaceous glands. One way to dispense with the oil on skin is to cleanse, exfoliate, use toner, and experiment with products that will minimize the oil produced. The problem is that a person's sebaceous glands will continue to make more oil, putting the individual in a similar situation as before the skin care routine. In addition, many individuals apply make-up, skin-moisturizers or other cosmetic formulations to their skin which may prove to be an additional source of oil.

As an alternative to skin care routines, individuals may use thin, disposable tissues or polymeric film blotters to blot oil and/or sebum from the skin periodically throughout the day, namely polypropylene film or rice paper type products. Oil absorbing wipes for removing facial oil have been described in the art. These wipes generally must be thin, conformable and non-abrasive.

Conventional paper type wipes have been used to remove facial oil. For example, wipes containing natural fiber, such as cellulose or hemp fiber, have been used. These oil absorbent papers however are often irritating to the skin due to the hard and stiff nature of the fibers. To improve their smoothness, these papers have been continuously calendered and/or coated with powders such as calcium carbonate and sizing agents. Calendering however is not necessarily permanent and surface fibers can reform into a rough surface unless substantial amounts of binder or sizing agents are used, which will typically decrease oil absorption. In addition, calendaring reduces the bulk of such paper wipes, which in turn can further reduce the absorption properties of the paper wipes. Furthermore, paper wipes are typically poor indicators as to their effectiveness, as papers generally do not significantly change appearance when they have absorbed oil or sebum. More particularly, there is little change in opacity or color in the paper when oil is absorbed. Difficulty in confirming oil removal means that users of the oil clearing paper can not evaluate if or how much sebum or oil is removed from the surface when using an oil absorbing paper.

In comparison, oil absorbing wipes comprising a porous thermoplastic film tend to exhibit better indication properties in confirming removal of oil or sebum following wiping as compared to oil absorbing papers. It is believed that the reason for this improved oil removal indicating functionality is that porous thermoplastic films exhibit low light transmittance before oil absorption because of irregular reflection of light, but the light transmittance increases substantially after the micro-pores of the film are filled with oils which can produce a change in the film's opacity or light transmittance, and therefore appearance. This change in opacity can provide a visual cue to the user to help confirm the removal of oil or sebum from a surface. However, a thermoplastic film in general tends to be very limited in its ability to absorb fluids. As a result, such film-containing wipes also suffer from limited capacity to absorb oil or sebum.

Therefore, there is a need for a relatively thin absorbent wipe which is capable of absorbing oil or sebum, and which demonstrates improved absorbent properties, such as absorbent capacity and wicking distance. There is also a need for such a wipe to provide absorption indication properties to the user.

### SUMMARY

In response to the needs discussed above, a laminated oil absorbing wipe is presented.

In some aspects, a laminated oil absorbing wipe comprises a non-pigmented thermoplastic nonwoven substrate layer (non-pigmented layer) and a pigmented thermoplastic nonwoven substrate layer (pigmented layer) where the wipe has a bulk of between 0.2 mm and 1.0 mm, where at least a portion of the non-pigmented layer is configured to undergo a change in opacity upon the absorption of a bodily oil so that the portion is at least partially translucent or transparent to light and the color of the pigmented layer becomes visible through the partially translucent or transparent portion, and where the wipe has an oil absorption capacity of at least about 1 g/g as measured by the Oil Absorbency Test. In some aspects, the pigmented layer is a different color than the non-pigmented layer. In some aspects, at least the non-pigmented layer is embossed. In some aspects, the non-pigmented layer and the pigmented layer is selected from spunlace, meltblown or coform. In some aspects, the non-pigmented layer exhibits a decrease in opacity of at least about 5% upon exposure to about 6 mg/cm² human oil, as measured by the Opacity Test. In some aspects, the wipe has a vertical wicking capacity of at least about 0.6 g/cc as measured by the Vertical Wicking Capacity Test. In some aspects, the wipe has a vertical wicking distance rate of at least about 6 mm in one minute, as measured by the Vertical Wicking Distance Test. In some aspects, the wipe has a vertical wicking capacity of at least about 0.12 mm/sec as measured by the Vertical Wicking Distance Test. In some aspects, neither the non-pigmented layer nor the pigmented layer is a polymeric film or film-like material.

In some aspects, a method of absorbing oil and/or sebum from skin comprises: a) providing a non-pigmented thermoplastic nonwoven substrate layer (non-pigmented layer) suitable for applying to skin; b) providing a pigmented thermoplastic nonwoven substrate layer (pigmented layer); c) laminating the non-pigmented layer onto the pigmented layer to form a laminated wipe having a pigmented side and a non-pigmented side; d) applying the non-pigmented side of the laminated wipe to human skin; and e) wiping oil and/or sebum from the skin; wherein the laminate has a bulk between about 0.2 mm and 1.0 mm; and wherein the wipe has an oil absorption capacity of at least about 1 g/g as measured by the Oil Absorbency Test. In some aspects, the non-pigmented layer of the laminated wipe exhibits a decrease in opacity of at least about 5% upon exposure to about 8 mg/cm² human oil, as measured by the Opacity Test to provide a visual cue. In some aspects, the method further comprises the step of viewing the visual cue. In some aspects, the method further comprises the step of embossing the non-pigmented layer. In some aspects, the method comprised the step of heat embossing the laminated wipe. In some aspects, the non-pigmented layer and the pigmented layer is selected from spunlace, meltblown or coform. In some aspects, the laminated wipe has a vertical wicking capacity of at least about 0.6 g/cc as measured by the Vertical Wicking Capacity Test. In some aspects, the laminated wipe has a vertical wicking distance rate of at least about 6 mm in one minute, as measured by the Vertical Wicking Distance Test. In some aspects, the laminated wipe has a vertical wicking capacity of at least about 0.12 mm/sec as measured by the Vertical Wicking Distance Test. In some aspects, the neither the non-pigmented layer nor the pigmented layer is a polymeric film or film-like material.

Numerous other features and advantages of the present invention will appear from the following description. In the description, reference is made to exemplary aspects of the invention. Such aspects do not represent the full scope of the invention. Reference should therefore be made to the claims herein for interpreting the full scope of the invention. In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

### FIGURES

The foregoing and other features, aspects and advantages of the present invention will become better understood with regard to the following description, appended claims and accompanying drawings where:

FIG. 1 is a cross-section view of a laminated wipe of the present invention;

FIG. 2 is a schematic diagram of one version of a method and apparatus for producing a meltblown thermoplastic substrate;

FIG. 3 is a schematic diagram of one embodiment of a process line for making the laminate construction of the present invention;

FIG. 4 is an embodiment of a process for combining the layers of the laminate construction of the present invention;

FIG. 5 is another embodiment of a process for combining the layers of the laminate construction of the present invention;

FIG. 6 is a table showing Vertical Wicking test results;

FIG. 7 is a table showing Absorbent Capacity test results;

FIG. 8 is a graph demonstrating the Vertical Wicking Distance results over time;

FIG. 9 is a graph demonstrating the Vertical Wicking Capacity over time;

FIG. 10 is graph demonstrating the Oil Absorbent Capacity of the substrates; and

FIG. 11 is a graph demonstrating the Vertical Wicking Absorbency.

Repeated use of reference characters in the present specification and drawings is intended to represent the same or analogous features or elements of the present invention.

### Test Methods

Unless otherwise stated, all tests are conducted at a temperature of 21° C. and a relative humidity between 10% and 60%.

### Transparency Test

The effect of skin oil absorption on the transparency of the webs was measured using a Gardiner Haze Guard Plus Hazemeter following the procedure in ASTM D1003. The transparency of the webs is measured before and after oil absorption and is reported as percent (%). Transparency with a value of 0 indicates no light transmittance. Upon absorption of oil the transparency value will increase providing an indication to the user that the web has absorbed skin oil. The higher the change, the greater the indication of absorption.

### Opacity Test

The percent opacity of the nonwoven layer may be measured as is known in the art using a HunterLab Color Difference Meter, Model DP 9000 in accordance with ASTM E1347 (“Standard Test Method for Color and Color-Difference Measurement by Tristimulus (Filter) Colorimetry”). The test is based on a percentage of light which passes through the sample. For example, when no light passes through the sample, the sample will have 100% opacity. Conversely, 0% opacity corresponds to a transparent sample.

### Oil Absorbent Capacity Test

This test is used to determine the absorbent capacity of materials in terms of both the weight of testing fluid that is absorbed by the specimen and as a percentage of its unit weight. This test was designed to determine the amount of oil absorbed and includes immersing a rectangular specimen in mineral oil for a specific time period. The specimen is then suspended vertically and allowed to drain. The absorbent capacity, specific capacity, and percent absorption can then be calculated.

### Preparation of Apparatus and Material:

1. Fill the container with the recommended minimum depth of 51 mm of mineral oil (white mineral (paraffin), +30 Saybolt color, NF grade, 80-90 S.U. (Saybolt Universal) viscosity; obtain from E. K. Industries part number 6228-1GL, or equivalent) to ensure the specimens can be completely submerged.
2. Verify the testing fluid temperature is 23±3° C.

### Test Specimen Preparation and Testing:

1. Cut specimens using a 50 mm by 76 mm (2 by 3 inch) die.
2. Weigh each specimen to the nearest 0.01 gram and record the value as the Dry Weight.
3. Tare the weighing dish.
4. Attach specimens to a diamond-shape clamp so that when hung to drain, one corner is lower than the rest of the specimen.
5. Start the timing device and simultaneously place the specimen(s) into the testing fluid.
6. Soak specimens for 3 minutes in the oil.
7. Hang specimens so that one corner is lower than the rest of the specimen.
8. Allow to drain for 3 minutes.
9. At the end of the specified draining time, remove the specimen by holding the weighing dish under it and releasing it from the clamping device.
10. Weigh the wet specimen to the nearest 0.01 gram and record the value as the Wet Weight.
11. Report the individual dry and wet weights recorded for each specimen to the nearest 0.01 gram.
12. Calculate and report the following:

$$Absorbent Capacity ( g ) = Wet Weight ( g ) - Dry Weight ( g )$$

$$Specific Capacity ( g \text{/} g ) = \frac{Absorbent Capacity ( g )}{Dry Weight ( g )}$$

$$\% Absorption = Specific Capacity ( g \text{/} g ) \times 100$$

### Vertical Wicking Distance Test

This method is used to measure the rate at which an oil is absorbed into nonwoven and tissue products as a result of capillary action. This test is applicable for any absorbent material, and is used to determine the affects of capillary action of a fluid on a fabric which is suspended vertically and partially immersed in the fluid.

### Preparation of Apparatus and Material

1. Fill a reservoir with mineral oil (+30 Saybolt color, NF grade, 80-90 S.U. (Saybolt Universal) viscosity, available from Sommeborn Chemical and Refinery Corp., Division of Witco Chemical Company, or equivalent).
2. Adjust the height of a specimen holder so that the lower edge of the strip (test specimen) will extend approximately 6 mm (0.25 inch) into the fluid.

### Test Specimen Preparation and Testing:

1. Cut specimens 25 mm by 76 mm±2.5 mm (1 by 3±0.1 inch). Specimens may be cut in either directions of the material, machine (MD) or cross direction (CD) as desired. Obtain the test specimens from areas of the sample that are free of folds, wrinkles, or any distortions that make these abnormal from the rest of the test material.
2. Clamp the desired amount of test specimens to the specimen holder stand with the long dimension vertical to the fluid and the lower end hanging over the side of the reservoir to avoid prematurely wetting the specimen. Adjust the specimen height so that the lower edge of the strip will extend approximately 25.4 mm (1 inch) into the fluid.
3. Place the free end of the specimen in the test fluid and start the stopwatch as soon as the specimen contacts the oil.
4. Observe the fluid as it migrates up the specimen(s). Record the height in centimeters of the lowest point of the migrating fluid every 15 seconds using a ruler, or other equivalent measuring device.
5. The test is terminated when the specimen has been tested for 300 seconds.
6. Report the results of the fluid migration in centimeters for each of the time intervals.
7. Calculate Wicking Distance Rate as follows:

$$Vertical Wicking Distance Rate ( cm \text{/} sec ) = \frac{Wicking Distance}{Time ( or desired time interval )}$$

### Vertical Wicking Capacity Test and Wicking Capacity Rate

This test is used to determine the wicking capacity of materials in terms of the weight of testing fluid that is absorbed by the specimen. This test was designed to determine the amount of oil absorbed through wicking. This test is conducted in a similar manner to the Vertical Wicking Distance Test above. However, the specimen holder should have the capability of measuring the weight of the test specimen throughout the test.

### Preparation of Apparatus and Material

1. Fill a reservoir with mineral oil (+30 Saybolt color, NF grade, 80-90 S.U. (Saybolt Universal) viscosity, available from Sommeborn Chemical and Refinery Corp., Division of Witco Chemical Company, or equivalent).
2. Adjust the height of a specimen holder so that the lower edge of the strip (test specimen) will extend approximately 6 mm (0.25 inch) into the fluid.

### Test Specimen Preparation and Testing:

1. Cut specimens 25 mm by 76 mm±2.5 mm (1 by 3±0.1 inch). Specimens may be cut in either direction of the material, machine (MD) or cross direction (CD) as desired. Obtain the test specimens from areas of the sample that are free of folds, wrinkles, or any distortions that make these abnormal from the rest of the test material.
2. Clamp the desired amount of test specimens to the specimen holder stand so that the long dimension vertical to the fluid, weigh each specimen to the nearest 0.01 gram and record the value as the Dry Weight. Tare the weighing device. Adjust the stand so that the lower end of the specimen hangs over the side of the reservoir to avoid prematurely wetting the specimen. Adjust the specimen height so that the lower edge of the strip will extend approximately 25.4 mm (1 inch) into the fluid.
3. Place the free end of the specimen in the test fluid and start the stopwatch as soon as the specimen contacts the oil.
4. Observe the fluid as it migrates up the specimen(s). Record the weight in grams to the nearest 0.01 grams every 15 seconds.
5. The test is terminated when the specimen has been tested for 300 seconds.
6. Report the results of the fluid migration in grams for each of the time intervals.
7. Calculate the Vertical Wicking Capacity as follows:

$$Vertical Wicking Capacity ( g ) = Wet Weight ( g ) - Dry Weight ( g )$$

$$Vertical Wicking Capacity Rate ( g \text{/} sec ) = \frac{Wet Weight ( g ) - Dry Weight ( g )}{Time ( or desired time interval )}$$

### Definitions

It should be noted that, when employed in the present disclosure, the terms “comprises,” “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

The term “coform” is intended to describe a blend of meltblown fibers and cellulose fibers that is formed by air forming a meltblown polymer material while simultaneously blowing air-suspended cellulose fibers into the stream of meltblown fibers. The coform material may also include other materials, such as superabsorbent materials. The meltblown fibers containing wood fibers and/or other materials are collected on a forming surface, such as provided by a foraminous belt. The forming surface may include a gas-pervious material, such as spunbonded fabric material, that has been placed onto the forming surface.

The term “fiber diameter” is the average fiber diameter measured from a sufficient sample size of melt blown fibers or fiber segments to result in a relatively stable mean. Manual or automated measurement techniques can be used to acquire the fiber values.

The term “meltblown fibers” refers to fibers formed by extruding a molten thermoplastic material through a plurality of fine, usually circular, die capillaries as molten threads or filaments into a high velocity, usually heated, gas (e.g., air) stream which attenuates the filaments of molten thermoplastic material to reduce their diameter. In the particular case of a coform process, the meltblown fiber stream intersects with one or more material streams that are introduced from a different direction. Thereafter, the meltblown fibers and other materials are carried by the high velocity gas stream and are deposited on a collecting surface. The distribution and orientation of the meltblown fibers within the formed web is dependent on the geometry and process conditions. Under certain process and equipment conditions, the resulting fibers can be substantially “continuous,” defined as having few separations, broken fibers or tapered ends when multiple fields of view are examined through a microscope at 10× or 20× magnification. When “continuous” melt blown fibers are produced, the sides of individual fibers will generally be parallel with minimal variation in fiber diameter within an individual fiber length. In contrast, under other conditions, the fibers can be overdrawn and strands can be broken and form a series of irregular, discrete fiber lengths and numerous broken ends. Retraction of the once attenuated broken fiber will often result in large clumps of polymer.

The terms “nonwoven” and “nonwoven web” refer to materials and webs of material having a structure of individual fibers or filaments which are interlaid, but not in an identifiable manner as in a knitted fabric. The terms “fiber” and “filament” are used herein interchangeably. Nonwoven fabrics or webs have been formed from many processes such as, for example, meltblowing processes, spunbonding processes, air laying processes, and bonded-carded-web processes. The basis weight of nonwoven fabrics is usually expressed in ounces of material per square yard (osy) or grams per square meter (gsm) and the fiber diameters are usually expressed in microns. (Note that to convert from osy to gsm, multiply osy by 33.91.)

The term “polymer” includes, but is not limited to, homopolymers, copolymers, for example, block, graft, random, and alternating copolymers, terpolymers, etc., and blends and modifications thereof. Furthermore, unless otherwise specifically limited, the term “polymer” shall include all possible configurational isomers of the material. These configurations include, but are not limited to isotactic, syndiotactic, and atactic symmetries.

The term “polyolefin” as used herein generally includes, but is not limited to, materials such as polyethylene, polypropylene, polyisobutylene, polystyrene, ethylene vinyl acetate copolymer, and the like, the homopolymers, copolymers, terpolymers, etc., thereof, and blends and modifications thereof. The term “polyolefin” shall include all possible structures thereof, which include, but are not limited to, isotatic, synodiotactic, and random symmetries. Copolymers include atactic and block copolymers.

The terms “spunbond” and “spunbonded fiber” refer to fibers which are formed by extruding filaments of molten thermoplastic material from a plurality of fine, usually circular, capillaries of a spinneret, and then rapidly reducing the diameter of the extruded filaments.

The term “thermoplastic” describes a material that softens when exposed to heat and which substantially returns to a non-softened condition when cooled to room temperature.

### DETAILED DESCRIPTION

In general, the present invention is directed to disposable, thermoplastic, nonwoven oil absorbing wipes which are suitable for use in a variety of applications, including absorbing oil and/or sebum. For example, the wipes of the present invention may be suitable for use on human skin, such on a person's face. In certain aspects, the wipes may additionally or alternatively be used to remove makeup or other cosmetic compositions which comprise oils or oily substances.

The oil absorbing wipes of the present invention are generally of a multi-layer construction and include a non-pigmented thermoplastic nonwoven substrate layer (non-pigmented layer) secured to a pigmented thermoplastic nonwoven substrate layer (pigmented layer) to form a laminate. For instance, the non-pigmented layer may be a flexible meltblown web and may be bonded to a pigmented flexible meltblown web. Desirably, the non-pigmented side of the laminated wipe is applied to human skin. Generally, the pigmented layer is not visible when viewed from the non-pigmented side of the wipe due to the opaque nature of the non-pigmented layer. However, as the wipe absorbs oil, the opacity of the non-pigmented substrate decreases (i.e., translucency increases), allowing the pigmented substrate to show through, and providing an indicator, or “visual cue” to the user that oil/sebum has been removed. This occurs, at least in part, from the sebum and/or oil absorbed by the non-pigmented layer preventing light from adequately reflecting from the nonwoven layer.

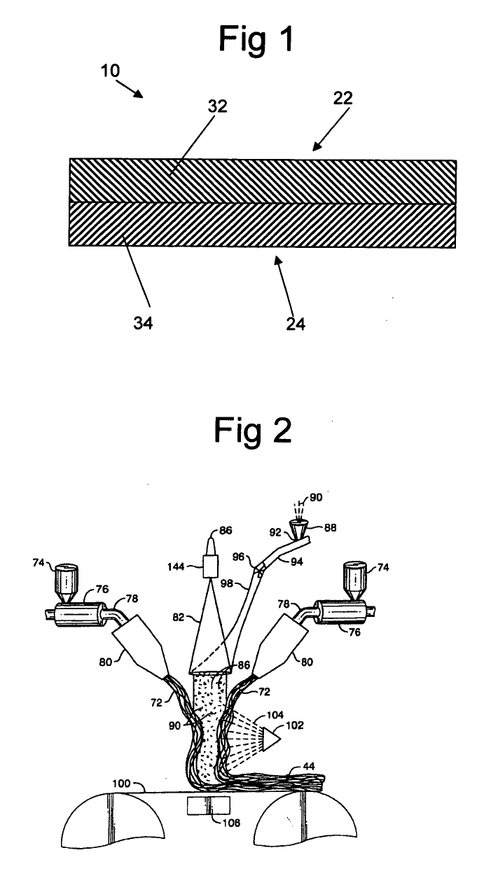

Referring to FIG. 1, one particular embodiment of an oil absorbing wipe 10 of the present invention is shown that includes a non-pigmented thermoplastic nonwoven substrate layer 32 and a pigmented thermoplastic nonwoven substrate layer 34. In this particular embodiment, the non-pigmented layer 32 is laminated to the pigmented layer 34. With this particular construction, surface 22 and surface 24 define external surfaces of the wipe 10 for contacting skin. It should of course be understood that the wipe 10 may also include additional layers, so long as the non-pigmented and pigmented layers 32 and 34 are positioned adjacent to each other. Prior to use, the pigmented layer 34 is not generally visible when the wipe 10 is viewed from the non-pigmented surface 22 side. However, the absorption of oil by the non-pigmented layer 32 causes at least a portion of the layer 32 to become at least partially translucent or transparent (i.e., less opaque) so that the color of the pigmented layer 34 becomes visible. For example, the portion of the non-pigmented layer 32 that contacts the bodily oil may have a percent opacity of about 60% or less, such as about 40% or less, or from 1% to about 20%, as measured by the Opacity Test.

To gain a better understanding of the present invention, the following description is provided. For exemplary purposes only, aspects of the description pertaining to the substrate layers may focus on meltblown substrates. However, it is understood that suitable substrates for the present invention also include other thermoplastic nonwoven substrates, including spunlace, coform, and the like, without departing from the scope of the present invention.

In an exemplary aspect, the wipe substrates of the present invention are thermoplastic nonwoven webs. In some aspects, the substrates desirably are not film-like (i.e., not a thermoplastic film or a consolidated nonwoven of thermoplastic micro-fibers which resembles a film). In some aspects, the nonwoven can have an average size of 10 micrometers or less, such as about 7 micrometers or less, or about 5 micrometers or less. In other aspects, it can be desirable that the nonwoven webs have a pore size of greater than about 10 microns, or greater than about 15 microns, such as about 10-300 microns, or 15-200 microns, or 20-100 microns. In some aspects, the fibers can also have a desirable denier. For example, the fibers can be formed to have a denier per filament (i.e., the unit of linear density equal to the mass in grams per 9000 meters of fiber) of less than about 6, such as less than about 3, or from about 0.5 to about 3. In addition, the fibers can have an average diameter of from about 0.1 to about 20 micrometers, such as from about 0.5 to about 15 micrometers, or from about 1 to about 10 micrometers.

Suitable nonwoven substrates can be formed by a variety of known forming processes, including airlaying, meltblowing, spunbonding, or bonded carded web formation processes, for example.

“Airlaid” refers to a porous web formed by dispersing fibers in a moving air stream prior to collecting the fibers on a forming surface. The collected fibers are then typically bonded to one another using, for example, hot air or a spray adhesive. Suitable examples of airlaid webs can be found in U.S. Pat. No. 5,486,166 to Bishop, et al., U.S. Pat. No. 6,960,349, issued to Shantz, et al. (Nov. 1, 2005), and U.S. Publication No. 2006/0008621 to Gusky, et al., all incorporated by reference in a manner that is consistent herewith.

“Spunbonded fibers” refers to small diameter fibers which are formed by extruding molten thermoplastic material as filaments from a plurality of fine, usually circular capillaries of a spinneret with the diameter of the extruded filaments then being rapidly reduced to fibers as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al., the contents of which are incorporated herein by reference in a manner that is consistent herewith. Spunbond fibers are generally continuous and have diameters generally greater than about 7 microns, more particularly, between about 10 and about 20 microns.

“Bonded-carded web” refers to a web made from staple fibers sent through a combing or carding unit, which separates or breaks apart and aligns the fibers to form a nonwoven web. For example, the web may be a powder bonded carded web, an infrared bonded carded web, or a through-air bonded carded web. Examples of such materials may be found in U.S. Pat. No. 5,490,846 to Ellis et al.; U.S. Pat. No. 5,364,382 to Latimer; and U.S. Pat. No. 6,958,103 to Anderson, et al., incorporated herein by reference in a manner that is consistent herewith.

In one desirable aspect, the nonwoven substrate material can be a meltblown. “Meltblown” refers to fibers formed by extruding a molten thermoplastic material through a plurality of fine, usually circular, die capillaries as molten threads or filaments into converging high velocity gas (e.g., air) streams, generally heated, which attenuate the filaments of molten thermoplastic material to reduce their diameters. Thereafter, the meltblown fibers are carried by the high velocity gas stream and are deposited on a collecting surface or support to form a web of randomly dispersed meltblown fibers. Such a process is disclosed, for example, in U.S. Pat. No. 3,849,241 to Butin et al. Meltblowing processes can be used to make fibers of various dimensions, including macrofibers (with average diameters from about 40 to about 100 microns), textile-type fibers (with average diameters between about 10 and 40 microns), and microfibers (with average diameters less than about 10 microns). Meltblowing processes are particularly suited to making microfibers, including ultra-fine microfibers (with an average diameter of about 3 microns or less). Meltblown fibers may be continuous or discontinuous and are generally self bonding when deposited onto a collecting surface. Generally, any suitable thermoplastic polymer that may be used to form meltblown nonwoven webs may be used for the substrate of the scrubbing pads. For instance, in one desirable aspect of the invention, the substrate may include meltblown nonwoven webs formed with a polyolefin, such as polyethylene or a polypropylene thermoplastic polymer.

To form “coform” materials, additional components are mixed with the meltblown fibers as the fibers are deposited onto a forming surface. For example, the absorbent composition of the present invention and fluff, such as wood pulp fibers, may be injected into the meltblown fiber stream so as to be entrapped and/or bonded to the meltblown fibers. Exemplary coform processes are described in U.S. Pat. No. 4,100,324 to Anderson et al.; U.S. Pat. No. 4,587,154 to Hotchkiss et al.; U.S. Pat. No. 4,604,313 to McFarland et al.; U.S. Pat. No. 4,655,757 to McFarland et al.; U.S. Pat. No. 4,724,114 to McFarland et al.; U.S. Pat. No. 4,100,324 to Anderson et al.; and U.K. Patent No. GB 2,151,272 to Minto et al., all of which are incorporated herein by reference in a manner that is consistent herewith. Absorbent, elastomeric meltblown webs containing high amounts of superabsorbent are described in U.S. Pat. No. 6,362,389 to D. J. McDowall, and absorbent, elastomeric meltblown webs containing high amounts of superabsorbent and low superabsorbent shakeout values are described in pending U.S. Publication No. 2006/0004336 to X. Zhang et al., all of which are incorporated herein by reference in a manner that is consistent herewith.

A non-exhaustive list of possible thermoplastic polymers suitable for use in the substrates of the present invention include polymers or copolymers of polyolefins, polyesters, polypropylene, high density polypropylene, polyvinyl chloride, vinylidene chloride, nylons, polytetrafluoroethylene, polycarbonate, poly(methyl)acrylates, polyoxymethylene, polystyrenes, ABS, polyetheresters, or polyamides, polycaprolactan, thermoplastic starch, polyvinyl alcohol, polylactic acid, such as for example polyesteramide (optionally with glycerin as a plasticizer), polyphenylsulfide (PPS), poly ether ether ketone (PEEK), polyvinylidenes, polyurethane, and polyurea. Polymer alloys may also be used in the substrate, such as alloy fibers of polypropylene and other polymers such as polyester (PET). Compatibilizers may be needed for some polymer combinations to provide an effective blend. In some aspects, the fibers of the substrate can be elastomeric or non-elastomeric, as desired. In addition, the substrate layer may comprise a mixture of elastomeric fibers and non-elastomeric fibers.

Elastomeric material of the polymer fibers may include an olefin elastomer or a non-olefin elastomer, as desired. For example, the elastomeric fibers can include olefinic copolymers, polyethylene elastomers, polypropylene elastomers, polyester elastomers, polyisoprene, cross-linked polybutadiene, diblock, triblock, tetrablock, or other multi-block thermoplastic elastomeric and/or flexible copolymers such as block copolymers including hydrogenated butadiene-isoprene-butadiene block copolymers; stereoblock polypropylenes; graft copolymers, including ethylene-propylene-diene terpolymer or ethylene-propylene-diene monomer (EPDM) rubber, ethylene-propylene random copolymers (EPM), ethylene propylene rubbers (EPR), ethylene vinyl acetate (EVA), and ethylene-methyl acrylate (EMA); and styrenic block copolymers including diblock and triblock copolymers such as styrene-isoprene-styrene (SIS), styrene-butadiene-styrene (SBS), styrene-isoprene-butadiene-styrene (SIBS), styrene-ethylene/butylene-styrene (SEBS), or styrene-ethylene/propylene-styrene (SEPS), which may be obtained from Kraton Inc. under the trade designation KRATON elastomeric resin or from Dexco, a division of ExxonMobil Chemical Company under the trade designation VECTOR (SIS and SBS polymers); blends of thermoplastic elastomers with dynamic vulcanized elastomer-thermoplastic blends; thermoplastic polyether ester elastomers; ionomeric thermoplastic elastomers; thermoplastic elastic polyurethanes, including those available from Invista Corporation under the trade name LYCRA polyurethane, and ESTANE available from Noveon, Inc., a business having offices located in Cleveland, Ohio U.S.A.; thermoplastic elastic polyamides, including polyether block amides available from AtoFina Chemicals, Inc. (a business having offices located in Philadelphia, Pa. U.S.A.) under the trade name PEBAX; polyether block amide; thermoplastic elastic polyesters, including those available from E. I. Du Pont de Nemours Co., under the trade name HYTREL, and ARNITEL from DSM Engineering Plastics (a business having offices located in Evansville, Ind., U.S.A.) and single-site or metallocene-catalyzed polyolefins having a density of less than about 0.89 grams/cubic centimeter, available from Dow Chemical Co. (a business having offices located in Freeport, Tex., U.S.A.) under the trade name AFFINITY; and combinations thereof.

Other examples of elastomeric polyolefins include ultra-low density elastomeric polypropylenes and polyethylenes, such as those produced by “single-site” or “metallocene” catalysis methods. Such elastomeric olefin polymers are commercially available from ExxonMobil Chemical Co. of Houston, Tex. under the trade designations ACHIEVE (propylene-based), EXACT (ethylene-based), and EXCEED (ethylene-based). Elastomeric olefin polymers are also commercially available from DuPont Dow Elastomers, LLC (a joint venture between DuPont and the Dow Chemical Co.) under the trade designation ENGAGE (ethylene-based) Examples of such polymers are also described in U.S. Pat. Nos. 5,278,272 and 5,272,236 to Lai, et al., which are incorporated herein in their entirety by reference thereto for all purposes. Also useful are certain elastomeric polypropylenes, such as described in U.S. Pat. No. 5,539,056 to Yang, et al. and U.S. Pat. No. 5,596,052 to Resconi, et al., which are incorporated herein in their entirety by reference thereto for all purposes.

As used herein, a tri-block copolymer has an ABA structure where the A represents several repeat units of type A, and B represents several repeat units of type B. As mentioned above, several examples of styrenic block copolymers are SBS, SIS, SIBS, SEBS and SEPS. In these copolymers the A blocks are polystyrene and the B blocks are a rubbery component. Generally, these triblock copolymers have molecular weights that can vary from the low thousands to hundreds of thousands, and the styrene content can range from 5% to 75% based on the weight of the triblock copolymer. A diblock copolymer is similar to the triblock, but is of an AB structure. Suitable diblocks include styrene-isoprene diblocks, which have a molecular weight of approximately one-half of the triblock molecular weight having the same ratio of A blocks to B blocks.

In desired arrangements, the polymer fibers can include at least one material selected from the group consisting of styrenic block copolymers, elastic polyolefin polymers and co-polymers and EVA/EMA type polymers.

In some aspects, the elastomeric polymer fibers can be produced from a polymer material having a selected melt flow rate (MFR). Polymers with relatively low viscosity or medium to high melt flow rates may be useful in producing substrates for effective oil absorption. The melt flow rate of the polymer is measured according to ASTM D1238. In some aspects, the polymers used in the substrate forming process, such as a meltblowing operation, may have melt flow rates of greater than about 20 g/10 min, such as between about 50 g/10 min and about 3000 g/10 min, or between about 100 g/10 min and about 2000 g/10 min, or between about 200 g/10 min and about 1000 g/10 min according to ASTM D1238.

In some aspects, polymer formula may also include a plasticizer. Such a plasticizer may be present in an amount of about 0 wt % to about 50 wt %, based on the weight of the substrate.

One example of a method of forming a substrate 44 for use in the present invention is illustrated in FIG. 2. The dimensions of the apparatus in FIG. 2 are described herein by way of example. Other types of apparatus having different dimensions and/or different structures may also be used to form the substrate 44. As shown in FIG. 2, polymeric material 72 in the form of pellets can be fed through two pellet hoppers 74 into two single screw extruders 76 that each feed a spin pump 78. The polymeric material 72 may be a polypropylene polymer available under the trade designation BASELL 650X available from Basell Polyolefins of LyondellBasell Industries (having a place of business located in Houston, Tex., U.S.A.). In other aspects, the polymeric material may be a multicomponent elastomer blend available under the trade designation VISTMAXX 2370 from ExxonMobil Chemical Company (a business having offices located in Houston, Tex., U.S.A.), as well as others mentioned herein.

In addition, a pigment (not shown) can also be added into the pellet hoppers 74 for at least one of the substrates. Desirably, the pigment will be used when forming the pigmented nonwoven substrate of the present invention. The amount of pigment added will depend on several factors, including the desired color intensity, the color itself, the type of substrate and properties thereof, the type of pigment, and the like.

Returning to FIG. 2, each spin pump 78 feeds the polymeric material 72 to a separate meltblown die 80. Each meltblown die 80 may have 30 holes per inch (hpi). The die angle may be adjusted anywhere between 0 and 70 degrees from horizontal, and is suitably set at about 45 degrees. The forming height may be at a maximum of about 16 inches (40.6 cm), but this restriction may differ with different equipment.

A chute 82 having a width of about 24 inches (61 cm) wide may be positioned between the meltblown dies 80. The depth, or thickness, of the chute 82 may be adjustable in a range from about 0.5 to about 1.25 inches (1.3 cm to 3.2 cm), or from about 0.75 to about 1.0 inch (1.9 cm to 2.5 cm). A picker 144 connects to the top of the chute 82. The picker 144 is used to fiberize optional pulp and/or synthetic fibers 86. The picker 144 may be limited to processing low strength or debonded (treated) pulps, in which case the picker 144 may limit the illustrated method to a very small range of pulp types. In contrast to conventional hammermills that use hammers to impact the pulp fibers repeatedly, the picker 144 uses small teeth to tear the fibers 86 apart.

At an end of the chute 82 opposite the picker 144 is an additive feeder 88. Additives can include any desirable material, including but not limited to colorants, antistatic agents, absorbents, ion exchange resin particles, moisturizers, emollients, perfumes, fluid modifiers, odor control additives, and the like. The feeder 88 pours optional solid additives 90 into a hole 92 in a pipe 94 which then feeds into a blower fan 96. Past the blower fan 96 is a length of 4-inch (10-cm) diameter pipe 98 sufficient for developing a fully developed turbulent flow at about 5,000 feet per minute, which allows the additive 90 to become distributed. The pipe 98 widens from a 4-inch (10 cm) diameter to the 24-inch by 0.75-inch (61 cm by 1.9 cm) chute 82, at which point the additive 90 mixes with the optional pulp and/or synthetic fibers 86 and the mixture falls straight down and gets mixed on either side at an approximately 45-degree angle with the polymeric material 72. The mixture of optional additives 90, optional fibers 86, and polymeric material 72 falls onto a wire conveyor 100 moving from about 14 to about 35 feet per minute. However, before hitting the wire conveyor 100, a spray boom 102 sprays an optional liquid additive mixture 104 in a mist through the mixture. An under wire vacuum 106 is positioned beneath the conveyor 100 to assist in forming the substrate 44.

Once formed, the nonwoven web may then be bonded using any conventional technique, such as with an adhesive or autogenously (e.g., fusion and/or self-adhesion of the fibers without an applied external adhesive). Autogenous bonding, for instance, may be achieved through contact of the fibers while they are semi-molten or tacky, or simply by blending a tackifying resin and/or solvent with the polymers used to form the fibers. Suitable autogenous bonding techniques may include ultrasonic bonding, thermal bonding, through-air bonding, calendar bonding, and so forth. For example, the web may be further bonded or embossed with a pattern by a thermo-mechanical process in which the web is passed between a heated smooth anvil roll and a heated pattern roll. The pattern roll may have any raised pattern which provides the desired web properties or appearance. Desirably, the pattern roll defines a raised pattern which defines a plurality of bond locations which define a bond area between about 2% and 30% of the total area of the roll. Exemplary bond patterns include, for instance, those described in U.S. Pat. No. 3,855,046 to Hansen et al., U.S. Pat. No. 5,620,779 to Levy et al., U.S. Pat. No. 5,962,112 to Haynes et al., U.S. Pat. No. 6,093,665 to Sayovitz et al., as well as U.S. Design Pat. Nos. 428,267 to Romano et al.; 390,708 to Brown; 418,305 to Zander, et al.; 384,508 to Zander, et al.; 384,819 to Zander, et al.; 358,035 to Zander, et al.; and 315,990 to Blenke, et al., all of which are incorporated herein in their entirety by reference thereto for all purposes. The pressure between the rolls may be from about 5 to about 2000 pounds per lineal inch. The pressure between the rolls and the temperature of the rolls is balanced to obtain desired web properties or appearance while maintaining cloth like properties. As is well known to those skilled in the art, the temperature and pressure required may vary depending upon many factors including but not limited to, pattern bond area, polymer properties, fiber properties and nonwoven properties.

Regardless of the manner in which it is formed, a colorant (e.g., dye, pigment, etc.) is incorporated into the pigmented layer for imparting some perceivable difference in color between the non-pigmented and pigmented nonwoven layers. Possible colors that contrast well with a non-pigmented nonwoven layer that is white, for instance, include yellow, cyan, magenta, red, green, blue, orange, black, etc. The relative degree of contrast between the colors of each layer may be measured through a gray-level difference value. In a particular embodiment, the contrast may have a gray level value of about 45 on a scale of 0 to about 255, where 0 represents “black” and 255 represents “white.” The analysis method may be made with a Quantimet 600 Image Analysis System (Leica, Inc., Cambridge, UK). This system's software (QWIN Version 1.06A) enables a program to be used in the Quantimet User Interactive Programming System (QUIPS) to make the gray-level determinations. A control or “blank” white-level may be set using undeveloped Polaroid photographic film. An 8-bit gray-level scale may then be used (0-255) and the program allowed the light level to be set by using the photographic film as the standard. A region containing the other color (e.g., background or foreground) may then be measured for its gray-level value, followed by the same measurement of the activate carbon ink. The routine may be programmed to automatically calculate the gray-level value of the activated carbon ink. The difference in gray-level value between the non-pigmented and pigmented nonwoven layers may be about 45 or greater on a scale of 0-255, where 0 represents “black” and 255 represents “white.”

Suitable colorants may for use in the pigmented layer may include those dyes approved for use in foods, drugs, cosmetics (FD&C colors), drugs and cosmetics only (D&C colors), or only in topically applied drugs and cosmetics (external D&C colors). Examples of such dyes include FD&C Blue 2, FD & C Blue No 11, FD & C Blue No 12, FD &C Green No 13, FD & C Red No 13, FD & C Red No 140, FD&C Yellow No. 15, FD&C Yellow No. 16, D&C Blue No. 14, D&C Blue No. 19, D&C Green No. 15, D&C Green No. 16, D&C Green No. 18, D&C Orange No. 5, D&C Orange No. 14, D&C Orange No. 15, D&C Orange No. 110, D&C Orange No. 111, D&C Orange No. 117, FD&C Red No. 14, D&C Red No. 16, D&C Red No. 17, D&C Red No. 18, D&C Red No. 19, D&C Red No. 27, D&C Red No. 117, D&C Red No. 119, D&C Red No. 121, D&C Red No. 122, D&C Red No. 127, D&C Red No. 128, D&C Red No. 130, D&C Red No. 131, D&C Red No. 134, D&C Red No. 139, FD&C Red No. 140, D&C Violet No. 2, D&C Violet No. 12, D&C Yellow No. 17, D&C Yellow No. 18, D&C Yellow No. 111, D&C Brown No. 11, D&C Blue No. 16 and D&C Yellow No. 110. Other suitable dyes are described in 21 C.F.R. Part 74 and the CTFA Cosmetic Ingredient Handbook, published by the Cosmetics, Toiletry and Fragrancy Association, Inc. Still other suitable colorants include any organic and/or inorganic pigments, such as D&C Red 7, calcium lake, D&C Red 30, talc Lake, D&C Red 6, barium lake, Russet iron oxide, yellow iron oxide, brown iron oxide, talc, kaolin, mica, mica titanium, red iron oxide, magnesium silicate and titanium oxide; and organic pigment such as Red No 202, Red No 204, Red No 205, Red No 206, Red No 219, Red No 228, Red No 404, Yellow No 205, Yellow No 401, Orange No 401 and Blue No 404. Examples of oil soluble dyes include Red No 505, Red No 501, Red No 225, Yellow No 404, Yellow No 405, Yellow No 204, Orange No 403, Blue No 403, Green No 202 and Purple No 201. Examples of lake dye include various acid dyes which are laked with aluminum, calcium or barium.

The colorant may be incorporated into the polymer composition used to form the fibers of the pigmented layer, or it may simply be applied to all or only a portion of a surface of the pigmented layer. Any technique may be employed to apply the colorant to a surface of the nonwoven layer, such as printing, dipping, spraying, melt extruding, coating (e.g., solvent coating, powder coating, brush coating, etc.), spraying, and so forth. In one embodiment, for example, the colorant is printed onto the layer in the form of an ink. A variety of printing techniques may be used for applying the ink to the layer, such as gravure printing, flexographic printing, screen printing, laser printing, thermal ribbon printing, piston printing, etc. In one particular embodiment, ink-jet printing techniques are employed to apply the ink to the nonwoven layer. Ink-jet printing is a non-contact printing technique that involves forcing an ink through a tiny nozzle (or a series of nozzles) to form droplets that are directed toward the support. Two techniques are generally utilized, i.e., “DOD” (Drop-On-Demand) or “continuous” ink-jet printing. In continuous systems, ink is emitted in a continuous stream under pressure through at least one orifice or nozzle. The stream is perturbed by a pressurization actuator to break the stream into droplets at a fixed distance from the orifice. DOD systems, on the other hand, use a pressurization actuator at each orifice to break the ink into droplets. The pressurization actuator in each system may be a piezoelectric crystal, an acoustic device, a thermal device, etc. The selection of the type of ink jet system varies on the type of material to be printed from the print head. For example, conductive materials are sometimes required for continuous systems because the droplets are deflected electrostatically.

Prior to application, the colorant is typically dissolved or dispersed in a solvent to form an ink. Any solvent capable of dispersing or dissolving the components is suitable, for example water; alcohols such as ethanol or methanol; dimethylformamide; dimethyl sulfoxide; hydrocarbons such as pentane, butane, heptane, hexane, toluene and xylene; ethers such as diethyl ether and tetrahydrofuran; ketones and aldehydes such as acetone and methyl ethyl ketone; acids such as acetic acid and formic acid; and halogenated solvents such as dichloromethane and carbon tetrachloride; as well as mixtures thereof. The concentration of solvent in the ink formulation is generally high enough to allow easy application, handling, etc. If the amount of solvent is too large, however, the amount of activated carbon deposited on the substrate might be too low to provide the desired odor reduction. Although the actual concentration of solvent employed will generally depend on the type of activated carbon and the substrate on which it is applied, it is nonetheless typically present in an amount from about 40 wt. % to about 99 wt. %, in some embodiments from about 50 wt. % to about 95 wt. %, and in some embodiments, from about 60 wt. % to about 90 wt. % of the ink (prior to drying). The colorant may likewise constitute from about 0.01 to about 20 wt. %, in some embodiments from about 0.01 wt. % to about 10 wt. %, in some embodiments, from about 0.05 wt. % to about 5 wt. %, and in some embodiments, from about 0.1 wt. % to about 3 wt. % of the ink (prior to drying).

Besides the colorant, the ink may also include various other components as is well known in the art, such as colorant stabilizers, photoinitiators, binders, solvents, surfactants, humectants, biocides or biostats, electrolytic salts, pH adjusters, etc. For example, examples of such humectants include, but are not limited to, ethylene glycol; diethylene glycol; glycerine; polyethylene glycol 200, 400, and 600; propane 1,3 diol; propylene-glycolmonomethyl ethers, such as Dowanol PM (Gallade Chemical Inc., Santa Ana, Calif.); polyhydric alcohols; or combinations thereof. Other additives may also be included to improve ink performance, such as a chelating agent to sequester metal ions that could become involved in chemical reactions over time, a corrosion inhibitor to help protect metal components of the printer or ink delivery system, a biocide or biostat to control unwanted bacterial, fungal, or yeast growth in the ink, and a surfactant to adjust the ink surface tension. Other components for use in an ink are described in U.S. Pat. No. 5,681,380 to Nohr, et al. and U.S. Pat. No. 6,542,379 to Nohr, et al., which are incorporated herein in their entirety by reference thereto for all purposes.

In general, the basis weight of each substrate can be set as desired, keeping in mind that a lower basis weight may tend to provide more interstitial spaces or voids, which in turn can provide improved absorbent capacity. The basis weight will be dependent on several factors, including the type of polymer fibers, a process used form creating the substrate, and the like. In some aspects, the substrate will have a void volume between about 50% and 90%, such as between about 55% and 85%, or between about 65% and 80%. Suitable basis weights for the substrate can range between about 10 gsm and about 100 gsm, such as between about 20 gsm and about 50 gsm. The resulting wipe typically has a basis weight of from about 20 to about 200 grams per square meter (gsm), in some embodiments from about 30 to about 150 gsm, and in some embodiments, from about 40 to about 100 gsm. However, in some aspects, it is also desirable that the overall bulk (i.e., thickness) of the laminate of the present invention remains relatively low, typically in the range of about 200 microns to about 1 mm.

Substrates of the present invention can also have desirable densities. In general, low density materials are desirable to allow for adequate void volume suitable for absorbing oil and/or sebum. For example, in some aspects, suitable densities, as determined under a confining pressure of 0.05 psi (0.345 KPa can be at least a minimum of about 0.1 grams per cubic centimeter (g/cm³), such as at least about 0.25 g/cm³, or at least about 0.3 g/cm³, or up to about 0.4 g/cm³, within the range of about 0.20 to 0.35 g/cm³.

The substrates can be laminated using various methods known in the art. For example, the substrates can be intermittently joined by patterned or randomly deposited adhesive, thermal point bonding, ultrasonic bonding, hot nip pressing, crimping, embossing, or by directly forming the non-pigmented substrate onto the pigmented substrate, and combinations thereof. In some aspects, if the non-pigmented substrate is formed on the pigmented substrate during the production process (e.g., a meltblown process), then the non-pigmented substrate may optionally be extensible. In other aspects, if the non-pigmented substrate is thermally bonded to the pigmented substrate, the bond area can be less than 50%, such as less than 25% or greater than 1%.

In some aspects, various anchoring agents may be incorporated into at least one of the substrates for bonding with the polymeric material used to form the substrates, such as a meltspun web. In general, the anchoring agent may be any suitable material that is compatible with the polymeric material used to form the sustrates. For example, the anchoring agent may comprise synthetic fibers that are incorporated into one of the substrates, such as the pigmented substrate. The synthetic fibers may be incorporated into the substrate in an amount less than about 10% by weight, such as in an amount from about 3% to about 6% by weight. When present, the synthetic fibers bond to the meltspun fibers while remaining buried in the web to help anchor the non-pigmented substrate to the pigmented substrate. The synthetic fibers may comprise, for instance, polyolefin fibers such as polyethylene fibers and/or polypropylene fibers, polyester fibers, nylon fibers, and the like. The synthetic fibers may be made from a copolymer or terpolymer of any of the above listed polymers or may comprise a blend of polymers. The synthetic fibers may also comprise multicomponent fibers such as sheath and core bicomponent fibers. Such bicomponent fibers may include, for instance, polyethylene/polypropylene fibers, polypropylene/polyethylene fibers, or polyethylene/polyester fibers. In addition to thermal bonding, however, it should be understood that various other bonds may form, including mechanical bonds and chemical bonds, for instance, covalent or ionic.

As stated above, the wipe of the present invention is a laminate that includes the non-pigmented nonwoven layer positioned adjacent to the pigmented nonwoven layer and bonded together using any conventional technique, such as the adhesive or autogenous bonding techniques described above. In one embodiment, for example, the laminate passes through a nip formed between a pair of rolls, one or both of which are heated to melt-fuse the fibers. One or both of the rolls may also contain intermittently raised bond points to provide an intermittent bonding pattern. The pattern of the raised points is generally selected so that the nonwoven laminate has a total bond area of less than about 50% (as determined by conventional optical microscopic methods), and in some embodiments, less than about 30%. Likewise, the bond density is also typically greater than about 100 bonds per square inch, and in some embodiments, from about 250 to about 500 pin bonds per square inch. The bonding temperature (e.g., the temperature of the rollers) may be relatively low, such as from about 60° C. to about 250° C., in some embodiments from about 100° C. to about 200° C., and in some embodiments, from about 120° C. to about 180° C. Likewise, the nip pressure may range from about 1 to about 50 pounds per square inch, in some embodiments, from about 2 to about 40 pounds per square inch, and in some embodiments, from about 5 to about 20 pounds per square inch.

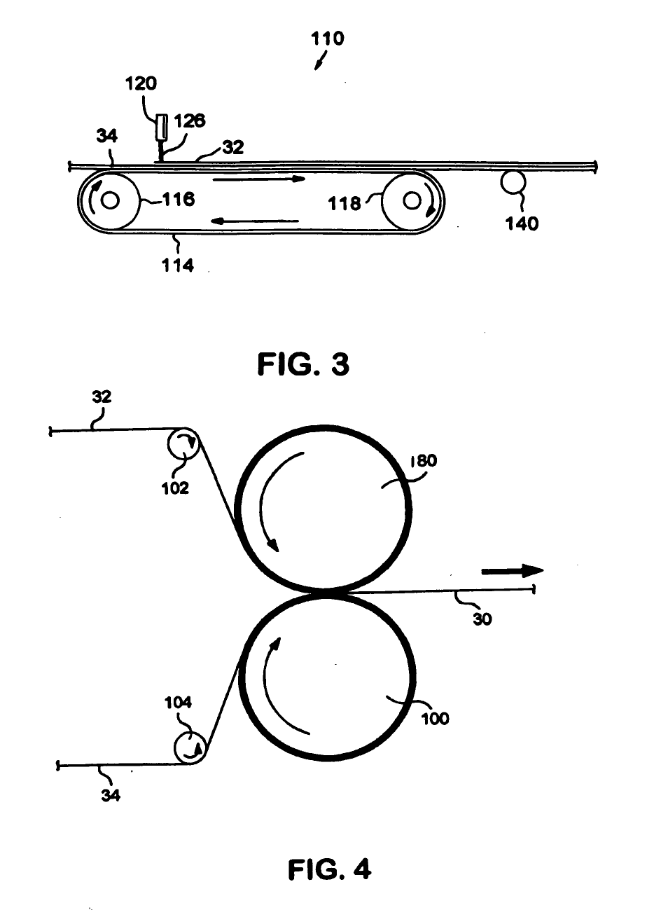

FIG. 3 illustrates one possible method of combining the layers wherein a non-pigmented meltblown layer 32 is formed directly onto the pigmented meltblown layer 34 at forming machine 10. The polymeric fibers on the surface of each substrate layer 32, 34 may then thermally bond as the non-pigmented meltblown layer 32 solidifies on the pigmented layer 34.

In an embodiment such as that illustrated in FIG. 3, it may be desirable to maintain an elevated temperature of the non-pigmented meltblown as it hits the pigmented substrate such that the non-pigmented meltblown material may bond with the pigmented substrate. This may be achieved through the use of heated air to carry the non-pigmented meltblown from the meltblown spinnerets to the pigmented substrate, and/or the use of vacuum beneath the pigmented substrate to pull a portion of the viscous non-pigmented meltblown material into the matrix of the pigmented substrate. For example, vacuum may be applied in the formation zone to help pull the polymer fibers into the web for better bonding. When vacuum is used, however, care should be taken to prevent excessive airflow in the vicinity of the pigmented substrate that could solidify the non-pigmented meltblown fibers prior to contacting the pigmented substrate. Narrow vacuum boxes, controlled air flow rates, pulsed vacuum, and other means, optionally coupled with radiative heating or other means of temperature control of the materials or fluids (e.g., air), may be used by those skilled in the art to optimize the bonding between the non-pigmented substrate and the pigmented substrate.

In some aspects, the pigmented substrate may be preheated or heated as the non-pigmented polymeric fibers are deposited thereon (whether by meltblown or spunbond formation directly on the pigmented substrate, or by joining a previously formed non-pigmented substrate to the pigmented substrate). For example, an IR lamp or other heating source may be used to heat the pigmented substrate in the vicinity where non-pigmented polymeric fibers contact the pigmented substrate web. By heating the surface of the pigmented substrate web, better bonding may be achieved, especially when the fibers are newly formed, cooling meltblown fibers. A combination of heating and suction beneath the pigmented substrate may be helpful.

In addition to the above techniques, if desired, an adhesive may also be applied in between the pigmented substrate 34 and the non-pigmented meltblown layer 32. The adhesive may further bond the layers together in addition to the bond that is formed between the meltblown fibers. Further, heat and/or pressure may be applied to the composite product to fuse the layers together by a thermal bonding process. Pressure may be applied using a mechanical press. For instance, point bonding, roll pressing and stamping may be used in order to further ensure that the polymeric fibers of the non-pigmented meltblown layer 32 are bonded to the polymer fibers contained within the pigmented substrate 34. In one preferred aspect, embossing can be used to bond the layers together.

Alternatively, the pigmented substrate and the non-pigmented substrate of the oil absorbing wipe may be separately formed, and then attached later, after formation. For example, as illustrated in FIG. 4, pigmented substrate 34 and non-pigmented substrate 32 may be guided together with guide rolls 102 and 104 and brought in contact between embossing roll 180 and roll 100.

When a thermoplastic-containing substrate layer has been previously formed and is no longer hot enough to readily bond to the fibers, heat may be applied to cause joining of the non-pigmented substrate with the pigmented substrate as the two are brought into contact or after the two are brought into contact. For example, the absorbent layer may be preheated sufficiently to cause partial fusion of the non-pigmented substrate as it touches the pigmented substrate, optionally with the assistance of mechanical compression. Alternatively, heat may be applied to either or both of the substrates after the two have been brought into contact to cause at least partial fusion of the thermoplastic layers. The heat may be applied conductively, such as by contacting one of the layers against a heated surface that heats the polymeric fibers sufficiently to cause fusion of parts of the non-pigmented substrate in contact with the pigmented substrate, preferably without heating the polymeric layer too much. Radiative heating, radio frequency heating (e.g., microwave heating), inductive heating, convective heating with heated air, steam, or other fluids, and the like may be applied to heat the layers while in contact with each other, or to independently heat either layer prior to being joined to the other.

Ultrasonic bonding and pattern bonding may also be applied. For example, a rotary horn activated by ultrasonic energy may compress parts of the non-pigmented substrate against the pigmented substrate and cause fusion of the polymeric fibers due to a welding effect driven by the ultrasound. Likewise, a patterned heated plate or drum may compress portions of the non-pigmented substrate in contact with the pigmented substrate to cause the compressed portions such that good attachment of the compressed portions to the pigmented substrate is achieved.

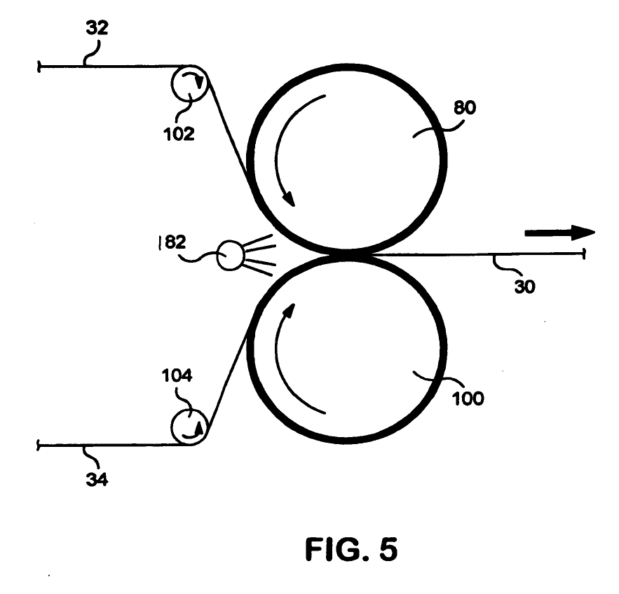

In an alternative embodiment, as shown in FIG. 5, the layers of the present invention may be brought together after formation, using thermal bonding in combination with an adhesive 182. The adhesive 182 may be applied to one or both layers of the wipe prior to contact with each other. In this embodiment, the pigmented substrate 34 and the non-pigmented substrate 32 are brought into contact with each other between roll 100 and roll 180. At least one of the rolls 100 or 180 is heated for causing thermal bonding to occur between the thermoplastic webs 32,34. As shown in FIG. 5, an adhesive applicator 182 sprays an adhesive in between the layers prior to the hot embossing or calender process.

An adhesive may be applied to one or both of the layers of the oil absorbing wipe by any method. For example, in addition to a spray method, as illustrated in FIG. 5, an adhesive may be applied through any known printing, coating, or other suitable transfer method. In addition, the adhesive may be any suitable adhesive which may firmly bond the layers of the pad together.

In some aspects of the present invention, additives may be incorporated into one or more of the substrates of the oil absorbent wipes. Additives, such as health and hygiene agents can be incorporated into the nonwoven webs by conventional means such as coating, adhesives or binders or mechanical entrapment in the web structure. In some aspects, the health and hygiene agents can also be coated onto a substrate. Coating of these agents in dry or wet form can be carried out by conventional techniques including, as appropriate, solvent slot coating, dip coating, spray coating, roll coating, gravure coating, melt coating, transfer coating, and the like. The health and hygiene agents can be dried if applied out of solvent or could be wet, such as by not evaporating solvent, or rewet with a suitable solvent. Particularly useful are various active ingredients or agents useful for delivering various benefits to the skin or hair during and after oil removal and cleansing. The active or nonactive agents can be coated onto the oil absorbing nonwoven substrate as a continuous or discontinuous coating.

The health and hygiene agents useful herein can be categorized by their therapeutic benefit or their postulated mode of action. However, it is to be understood that the ingredients useful herein can in some instances provide more than one therapeutic benefit or operate via more than one mode of action. The following health & hygiene ingredients are possible for use in the present invention. Anti-Acne Actives: examples of useful anti-acne actives include the keratolytics such as salicylic acid (o-hydroxybenzoic acid), derivatives of salicylic acid, retinoids such as retinoic acid and its derivatives (e.g., cis and trans); sulfur-containing D and L amino acids and their derivatives and salts, lipoic acid; antibiotics and antimicrobials; sebostats such as flavonoids; and bile salts such as scymnol sulfate and its derivatives, deoxycholate, and cholate. Anti-Wrinkle and Anti-Skin Atrophy Actives: examples of antiwrinkle and anti-skin atrophy actives include retinoic acid and its derivatives (e.g., cis and trans); retinol; retinyl esters; niacinamide, salicylic acid and derivatives thereof; sulfur-containing D and L amino acids and their derivatives and salts, thiols, hydroxy acids phytic acid, lipoic acid;lysophosphatidic acid, and skin peel agents (e.g., phenol and the like). Non-Steroidal Anti-Inflammatory Actives (NSAIDS): examples of NSAIDS include the following, propionic acid derivatives; acetic acid derivatives; fenamic acid derivatives; biphenylcarboxylic acid derivatives; and oxicams. Topical Anesthetics; examples of topical anesthetic drugs include benzocaine, lidocaine, bupivacaine, chlorprocaine, dibucaine, etidocaine, mepivacaine, tetracaine, dyclonine, hexylcaine, procaine, cocaine, ketamine, pramoxine, phenol, and pharmaceutically acceptable salts thereof. Artificial Tanning Agents and Accelerators; examples of artificial tanning agents and accelerators include dihydroxyacetaone, tyrosine, tyrosine esters such as ethyl tyrosinate, and phospho-DOPA. Sunscreen Actives; examples of sunscreens which are useful in the compositions of the present invention are those selected from the group consisting of 2-ethylhexyl p-methoxycinnamate, 2-ethylhexyl N,N-dimethyl-p-aminobenzoate, p-aminobenzoic acid, 2-phenylbenzimidazole-5-sulfonic acid, octocrylene, oxybenzone, homomenthyl salicylate, octyl salicylate, 4,4′-methoxy-t-butyldibenzoylmethane, 4-isopropyl dibenzoylmethane, 3-benzylidene camphor, 3-(4-methylbenzylidene)camphor, titanium dioxide, zinc oxide, silica, iron oxide and mixtures thereof. Other known active agents such as antibiotics or antiseptics may also be used.

In some aspects, the non-pigmented substrate of oil absorbent wipes of the present invention has the ability to change from opaque to translucent after absorbing only a moderate amount of oil, such as would be present on a person's skin (e.g., from 0 to 8 mg/cm²). More particularly, after absorbing skin oil at the levels excreted from common sebaceous glands, the non-pigmented substrate will turn translucent, thus allowing the color of the pigmented substrate to show through, providing a visual cue that the oil and/or sebum has been removed. Prior to use, the pigmented layer 34 is not generally visible when the wipe 10 is viewed from the non-pigmented surface 22. However, the absorption of oil by the non-pigmented layer 32 (e.g., about 6 mg/cm²) causes at least a portion of the layer 32 to become translucent or transparent so that the color of the pigmented layer 34 becomes visible. For example, the portion of the layer 32 that contacts the bodily oil may have a percent opacity of about 60% or less, or about 40% or less, or from 1% to about 20% as measured by the Opacity Test. In some aspects, the non-pigmented layer exhibits a decrease in opacity of at least about 5% upon exposure to at least about 6 mg/cm² human oil, such as at least about 10% or at least about 25%, as measured by the Opacity Test. This change in opacity occurs rapidly, such as about 30 seconds or less, in some embodiments about 15 seconds or less, and in some embodiments, about 5 seconds or less. In this manner, the cosmetic wipe of the present invention is capable of providing a user with the real-time ability to determine if or how much sebum was removed from the skin.

In some aspects, the visual cue is provided by the non-pigmented substrate having an initial transparency of about 65 percent or less, such as 60 percent or less with an ability to increase transparency by about 5% or more, such as by about 10% or more, or by about 20% or more with a relatively low level of oil loading (e.g., 6 mg/cm²). The effect of skin oil absorption on the transparency of the non-pigmented substrate can be measured using a HAZE-GUARD PLUS haze meter (available from BYK-Gardner USA, having a place of business Columbia, Md., U.S.A.) following the Transparency Test.

In some aspects, opacifying agents can be utilized. Suitable opacifying agents for use in the non-pigmented layer may include inorganic particles, such as silica, alumina, zirconia, magnesium oxide, titanium dioxide, iron oxide, zinc oxide, zeolites, silicates, titanates, zirconates, clays (e.g., smectite or bentonite), calcium carbonate, and barium sulfate; organic particles, e.g., carbon black and organic pigments; and so forth. The particles may possess various forms, shapes, and sizes depending upon the desired result, such as a sphere, crystal, rod, disk, tube, string, etc. The average size of the particles may be less than about 500 micrometers, in some embodiments from about 0.5 to about 100 micrometers, in some embodiments from about 1 to about 50 micrometers, and in some embodiments, from about 2 to about 40 micrometers.

If desired, the opacifying agent may be blended with a carrier resin to form a masterbatch. Among other things, the carrier resin enhances the compatibility of the opacifying agent with the base composition used to form the nonwoven web. Exemplary polymers for use in the carrier resin may include, for instance, high and low density polyethylene, polypropylene, polyoxymethylene, poly(vinylidine fluoride), poly(methyl pentene), poly(ethylene-chlorotrifluoroethylene), poly(vinyl fluoride), and polybutene. Particularly desired polymers are predominantly linear polymers having a regular structure. Examples of semi-crystalline, linear polymers that may be used in the present invention include polyethylene, polypropylene, blends of such polymers and copolymers of such polymers. The amount of the carrier resin employed will generally depend on a variety of factors, such as the type of carrier resin and base composition, the type of particles, the processing conditions, etc.

The carrier resin may be blended with the opacifying agent using any known technique, such as batch and/or continuous compounding techniques that employ, for example, a Banbury mixer, Farrel continuous mixer, single screw extruder, twin screw extruder, etc. If desired, the carrier resin and opacifying agent may be dry blended. After blending, the masterbatch may be processed immediately or pelletized for subsequent use. For example, the blend may be extruded into a water bath and cut into pellet form using a knife or other suitable cutting surface. Typically, the carrier resin constitutes from about 20 wt. % to about 80 wt. %, in some embodiments from about 30 wt. % to about 70 wt. %, and in some embodiments, from about 40 wt. % to about 60 wt. % of the masterbatch. The opacifying agent likewise normally constitutes from about 20 wt. % to about 80 wt. %, in some embodiments from about 30 wt. % to about 70 wt. %, and in some embodiments, from about 40 wt. % to about 60 wt. % of the masterbatch.

Regardless of the particular form of the masterbatch, it is ultimately blended with the base polymer composition (e.g., polypropylene) when it is desired to form the nonwoven web. Due to the presence of the carrier resin, the masterbatch may be miscible with the base composition. If the compositions are immiscible, they may simply be blended under shear or modified to improve their interfacial properties. The masterbatch may be blended with the base composition before melt extrusion or within the extrusion apparatus itself. The opacifying agent may constitute from about 0.1 wt. % to about 20 wt. %, in some embodiments from about 0.5 wt. % to about 10 wt. %, and in some embodiments, from about 1 wt. % to about 5 wt. % of the blend. The base melt-extrudable polymer may constitute from about 70 wt. % to about 99.9 wt. %, in some embodiments from about 80 wt. % to about 99.5 wt. %, and in some embodiments, from about 85 wt. % to about 98 wt. % of the blend. When employed, the carrier resin for the opacifying agent may also constitute from about 0.1 wt. % to about 20 wt. %, in some embodiments from about 0.5 wt. % to about 10 wt. %, and in some embodiments, from about 1 wt. % to about 5 wt. % of the blend.

The oil absorbing laminated wipes of the present invention can exhibit improved performance as compared to currently available commercial blotter wipes, such as natural fiber blotters, film or film-like materials. In terms of absorbent capacity, the laminated wipes of the present invention can absorb 40-55 wt % more oil than film or film-like material and 35-50 wt % more than natural fiber containing material when saturated with mineral oil for 3 minutes and drained for 3 minutes to remove the excess oil, as measured by the Oil Absorbent Capacity Test. The laminated wipes of the present invention also showed improved wicking. For example, the vertical wicking distances at 10 seconds for laminated wipes of the present invention can be 70-80% better than film-like materials and 45-70% better than natural fiber containing materials as measured by the Vertical Wicking Distance Test. In some aspects, the oil absorbing wipe of the present invention exhibits an oil absorption capacity of at least about 1 g/g as measured by the Oil Absorbent Capacity Test.

Further, the wipe may assume a variety of shapes, including but not limited to, generally circular, oval, square, rectangular, or irregularly shaped. Each individual wipe may be arranged in a folded configuration and stacked one on top of the other to provide a stack of wet wipes. Such folded configurations are well known to those skilled in the art and include c-folded, z-folded, quarter-folded configurations and so forth. For example, the wipe may have an unfolded length of from about 2.0 to about 80.0 centimeters, and in some embodiments, from about 10.0 to about 25.0 centimeters. The wipes may likewise have an unfolded width of from about 2.0 to about 80.0 centimeters, and in some embodiments, from about 10.0 to about 25.0 centimeters. The stack of folded wipes may be placed in the interior of a container, such as a plastic tub, to provide a package of wipes for eventual sale to the consumer. Alternatively, the wipes may include a continuous strip of material which has perforations between each wipe and which may be arranged in a stack or wound into a roll for dispensing. Various suitable dispensers, containers, and systems for delivering wipes are described in U.S. Pat. No. 5,785,179 to Buczwinski, et al.; U.S. Pat. No. 5,964,351 to Zander; U.S. Pat. No. 6,030,331 to Zander; U.S. Pat. No. 6,158,614 to Haynes, et al.; U.S. Pat. No. 6,269,969 to Huang, et al.; U.S. Pat. No. 6,269,970 to Huang, et al.; and U.S. Pat. No. 6,273,359 to Newman, et al., which are incorporated herein in their entirety by reference thereto for all purposes.

The present invention may be better understood with reference to the figures and the following examples.

### EXAMPLES

The following examples are provided to further illustrate the present invention and do not limit the scope of the claims. Unless otherwise stated, all parts and percentages are by weight. The examples were made on a meltblown coform process, similar to those described in U.S. Pat. No. 4,100,324 to Anderson et al. and U.S. Pat. No. 6,362,389 to McDowall et al., previously incorporated herein by reference. Unless otherwise stated, process conditions for each example using the meltblown coform process were as seen in Table 1 below.

TABLE 1
Key Process Conditions for Meltblown Examples

| | EXAMPLES 1-2 |
|---|---|
| Line Speed, DPM | 150 |
| (FPM = DPM × 1.125) | |
| Throughput (per tip) | 2.0 pih |
| Die Tip-To-Tip Distance (cm) | 0 - single die |
| Forming Height (cm) | 21 |
| Polymer | BASELL 650X |
| Pigment | 11115 BLUE |
| | PF441 |
| Pigment Amount | 1.0 wt % |
| Fluff (cellulosic fiber) | None |
| Surfactant | None |
| Primary Air Pressure (psi) | 1.0 |
| Primary Air Temperature (° C.) | 304 |
| Polymer Melt Temperature (° C.) | 266 |
| Carrier | No (formed on a |
| | wire) |

### Example 1

Two polypropylene meltblown substrates were produced on a coform line. One substrate had a basis weight of 30 gsm and the other had a basis weight of 20 gsm. The 30 gsm meltblown material included 1.0 wt % of 11115 BLUE PF441, SCC Code 07SAM0878, blue color pigment, available from Standridge Color Corporation. The color pigment was added to the polymer during the coform process. The 20 gsm meltblown did not contain any color pigment and was white in color. A 25.4 cm length by 25.4 cm width sample was then cut from each substrate.

The 20 gsm meltblown sample was laminated onto the 30 gsm blue melt-blown sample using a manual hydraulic press with heated plates (CARVER PRESS model #2518 available from Carver, Inc., having a place of business in Wabash, Ind. U.S.A.). The materials were simultaneously embossed with a checkered pattern at pressures ranging from 5 to 10 psi for 20-40 seconds at 230° F. (110° C.). The checkered plate measured 11″×8.5″ with a pattern coverage of 10.5″×8″ and had a depth of 2 mm. The individual checkers were 4 mm×4 mm square with 5 mm×5 mm space in between. The result was an embossed (textured) meltblown laminate.

The white fabric side when contacted with human oil, which turned the white fabric transparent and revealed the vivid color of the opposite side to give the impression that the fabric had turned color on contact with the facial oil. When the colored side was used, the pastel colored fabric turned a deeper color when contacted with the facial oil.

### Example 2

Two polypropylene meltblown substrates were produced on a coform line. Both substrates had a basis weight of 20 gsm. One of the 20 gsm meltblown materials included 1.0 wt % of 11115 BLUE PF441, SCC Code 07SAM0878, blue color pigment. The color pigment was added to the polymer during the coform process. The other 20 gsm meltblown did not contain any color pigment and was white in color. A 25.4 cm length by 25.4 cm width sample was then cut from each substrate.

The 20 gsm blue meltblown sample was compressed using the CARVER PRESS model #2518 at 20 psi for 20 seconds at 230° F. (110° C.). The 20 gsm non-pigmented meltblown sample was then laminated onto the compressed blue 20 gsm meltblown using the CARVER PRESS at 10 psi for 30 seconds at 230° F. (110° C.). The result was a non-textured meltblown laminate.

### Test Results

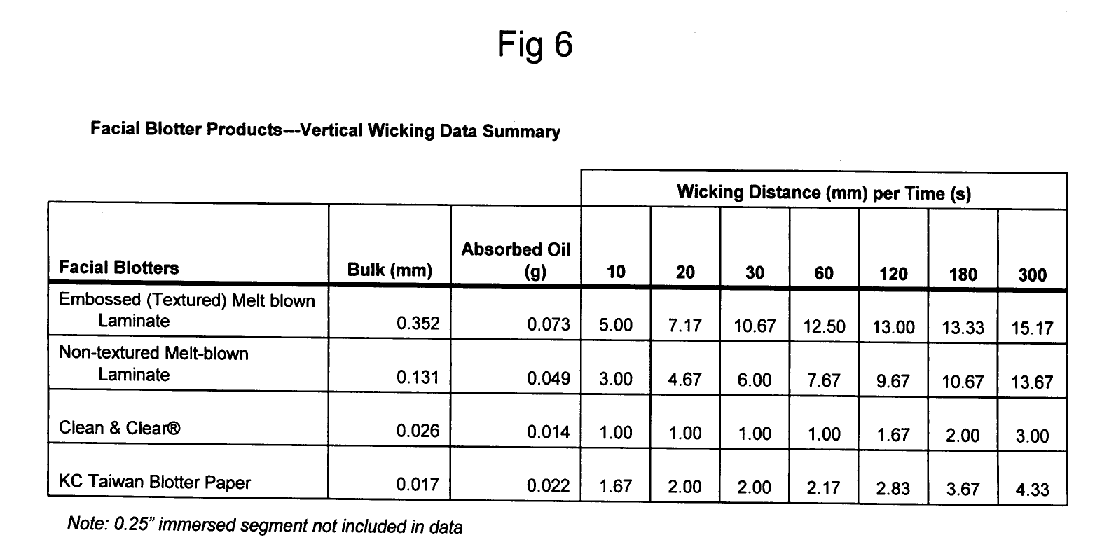

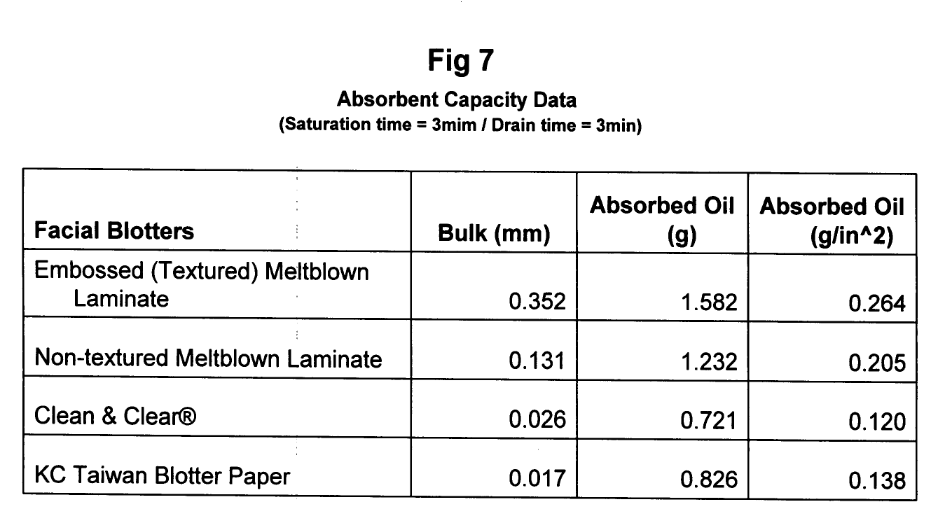

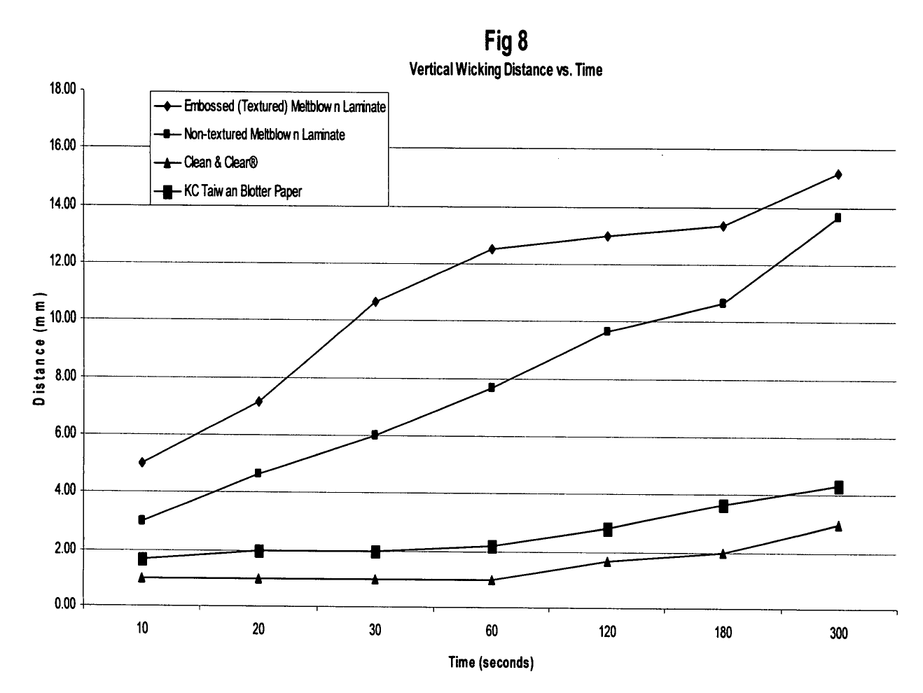

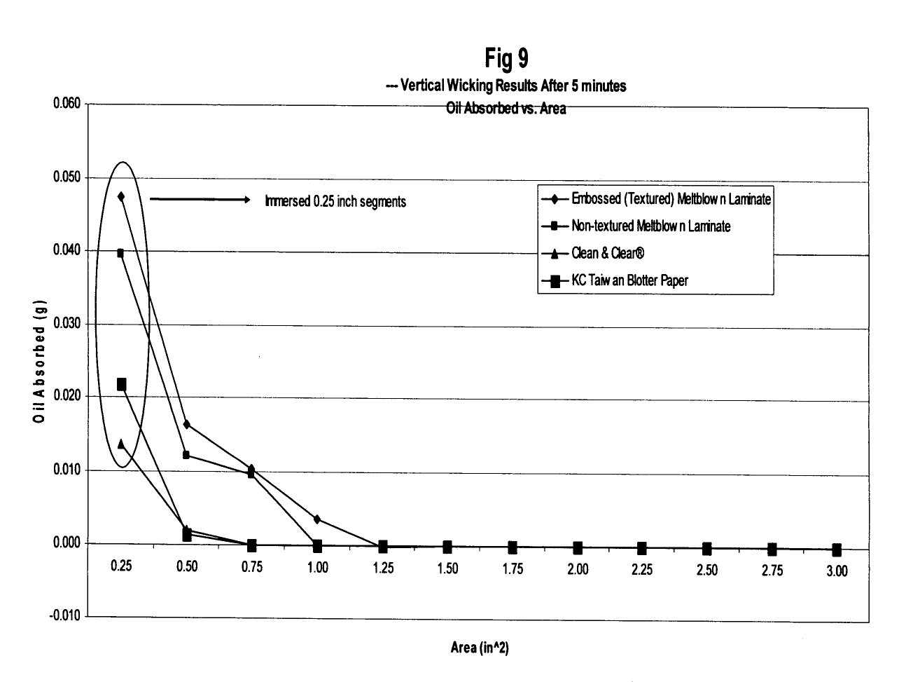

The laminates of Example 1 and Example 2 were then tested for various properties, and the results were compared to a commercially available film-like oil blotting material (CLEAN & CLEAR: Oil Absorbing Sheets, available from Johnson & Johnson, having a place of business in New Brunswick, N.J., U.S.A.), and blotter paper containing hemp fiber under the brand name KLEENEX (available from K-C Taiwan of Kimberly-Clark Corporation, having a place of business in Neenah, Wis., U.S.A.). The results can be seen in FIG. 6 and FIG. 7, which demonstrate that the wipes of the present invention provide superior vertical wicking distance and superior oil absorbent capacity when compared to commercial natural fiber products and commercial film products. In addition, FIG. 8 is a graph demonstrating the Vertical Wicking Distance results over time, and FIG. 9 is a graph demonstrating the Vertical Wicking Capacity over time.

In addition, various substrates of the present invention were tested for Oil Absorbent Capacity and Vertical Wicking Capacity. The substrates can be seen in Table 2:

TABLE 2

| Example | Description |
|---|---|
| Example 3 | 35 gsm HP (high polymer) coform |
| | 70% polymer blend (80/20 Achieve 3936G/VMX 2370) |
| | from Standridge Color Corp. SCC Code: 06SAM10251 |
| | 30% pulp (NF 405) from Weyerhaeuser |
| | 0.34 mm |
| Example 4 | Compressed 64 gsm HP (high polymer coform |
| | 70% polymer blend (80/20 Achieve 3936G/VMX 2370) |
| | from Standridge Color Corp. SCC Code: 06SAM10251 |
| | 30% pulp (NF 405) from Weyerhaeuser |
| | Material compressed from 0.64 mm to 0.15 mm with |
| | the use of CARVER press |
| Example 5 | 64 gsm HP (high polymer) coform |
| | 70% polymer blend (80/20 Achieve 3936G/VMX 2370) |
| | from Standridge Color Corp. SCC Code: 06SAM10251 |
| | 30% pulp (NF 405) from Weyerhaeuser |
| | 0.64 mm |
| Example 6 | 30 gsm MB |
| | 100% polymer (MF650x PP) from Basell |
| | 0.23 mm |
| Example 7 | 70 gsm Spunlace Microfiber |
| | Material used in KCP's KIMTECH SCIENCE Lens |
| | Cleaning Microfiber Wipes |
| | 0.47 mm |
| Comparative | 14 gsm Machine Glazed Tissue |
| Example 8 | Material used in KCP's Toilet seat cover dispensers - |
| | SCOTT Personal Seats |
| | 0.03 mm |
| Comparative | CLEAN & CLEAR |
| Example 0 | Oil Absorbing Sheets Johnson & Johnson |
| | 24 gsm |
| | 0.03 mm |

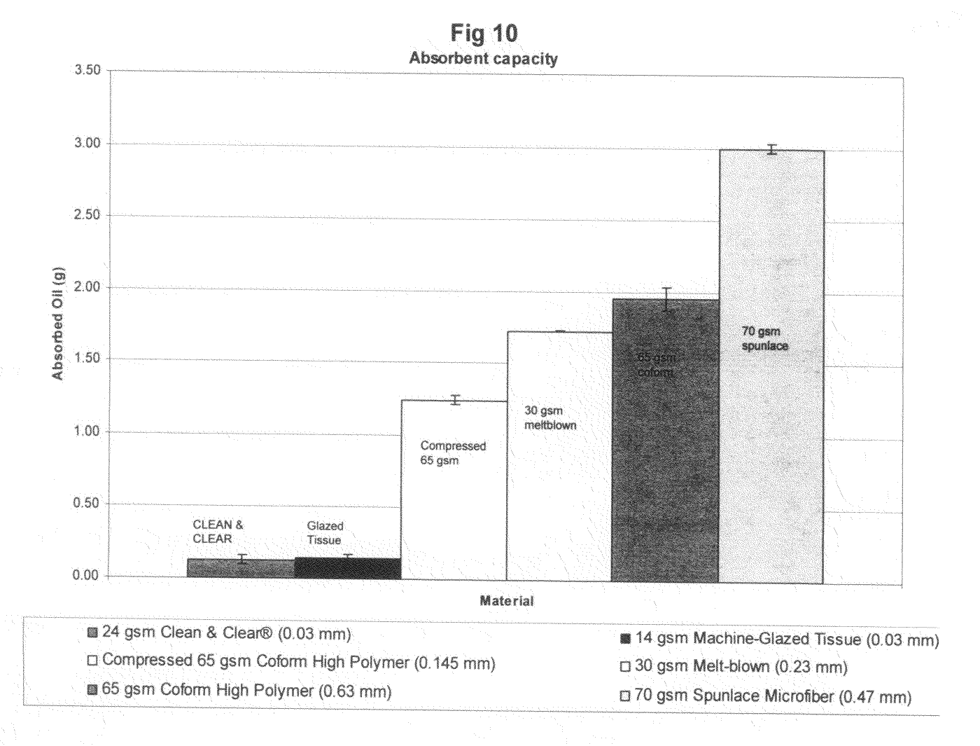

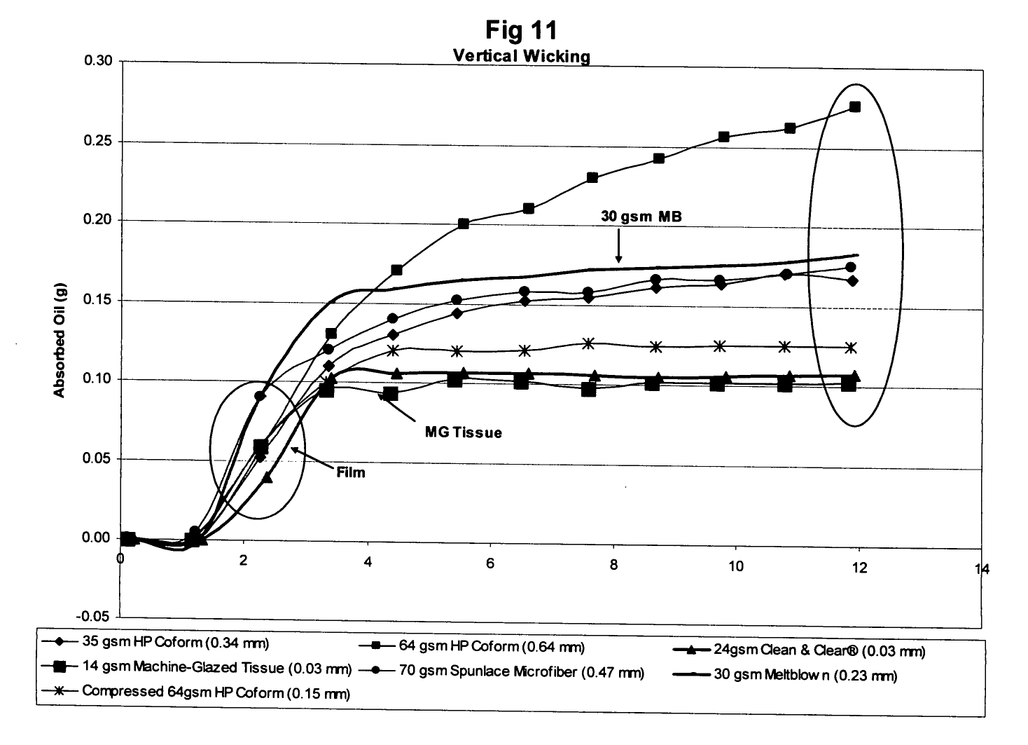

FIG. 10 is graph demonstrating the Oil Absorbent Capacity of the substrates, and FIG. 11 is a graph demonstrating the Vertical Wicking Absorbency. It can be seen that the substrates of the invention exhibit superior oil absorption properties to the commercial film and glazed tissue products.

It will be appreciated that details of the foregoing examples, given for purposes of illustration, are not to be construed as limiting the scope of this invention. Although only a few exemplary aspects of this invention have been described in detail above, those skilled in the art will readily appreciate that many modifications are possible in the examples without materially departing from the novel teachings and advantages of this invention. For example, features described in relation to one example may be incorporated into any other example of the invention.

Accordingly, all such modifications are intended to be included within the scope of this invention, which is defined in the following claims and all equivalents thereto. Further, it is recognized that many aspects may be conceived that do not achieve all of the advantages of some aspects, particularly of the desirable aspects, yet the absence of a particular advantage shall not be construed to necessarily mean that such an aspect is outside the scope of the present invention. As various changes could be made in the above constructions without departing from the scope of the invention, it is intended that all matter contained in the above description shall be interpreted as illustrative and not in a limiting sense.

What is claimed is:

1. A laminated oil absorbing wipe comprising a non-pigmented thermoplastic nonwoven substrate layer (non-pigmented layer) and a pigmented thermoplastic nonwoven substrate layer (pigmented layer) wherein the wipe has a bulk of between 0.2 mm and 1.0 mm, wherein at least a portion of the non-pigmented layer is configured to undergo a change in opacity upon the absorption of a bodily oil so that the portion is at least partially translucent or transparent to light and the color of the pigmented layer becomes visible through the partially translucent or transparent portion, and wherein the wipe has an oil absorption capacity of at least about 1 g/g as measured by the Oil Absorbency Test.

2. The wipe of claim 1 wherein the pigmented layer is a different color than the non-pigmented layer.

3. The wipe of claim 1 wherein at least the non-pigmented layer is embossed.

4. The wipe of claim 1 wherein the non-pigmented layer and the pigmented layer is selected from spunlace, meltblown or coform.

5. The wipe of claim 1 wherein the non-pigmented layer exhibits a decrease in opacity of at least about 5% upon exposure to about 6 mg/cm² human oil, as measured by the Opacity Test.

6. The wipe of claim 1 having a vertical wicking capacity of at least about 0.6 g/cc as measured by the Vertical Wicking Capacity Test.

7. The wipe of claim 1 having a vertical wicking distance rate of at least about 6 mm in one minute, as measured by the Vertical Wicking Distance Test.

8. The wipe of claim 1 having a vertical wicking capacity of at least about 0.12 mm/sec as measured by the Vertical Wicking Distance Test.

9. The wipe of claim 1 wherein neither the non-pigmented layer nor the pigmented layer is a polymeric film or film-like material.

10. A method of absorbing oil and/or sebum from skin comprising:
a) providing a non-pigmented thermoplastic nonwoven substrate layer (non-pigmented layer) suitable for applying to skin;
b) providing a pigmented thermoplastic nonwoven substrate layer (pigmented layer);
c) laminating the non-pigmented layer onto the pigmented layer to form a laminated wipe having a pigmented side and a non-pigmented side;
d) applying the non-pigmented side of the laminated wipe to human skin; and
e) wiping oil and/or sebum from the skin;
wherein the laminate has a bulk between about 0.2 mm and 1.0 mm; and
wherein the wipe has an oil absorption capacity of at least about 1 g/g as measured by the Oil Absorbency Test.

11. The method of claim 10 wherein the non-pigmented layer of the laminated wipe exhibits a decrease in opacity of at least about 5% upon exposure to about 6 mg/cm² human oil, as measured by the Opacity Test to provide a visual cue.

12. The method of claim 11 further comprising the step of viewing the visual cue.

13. The method of claim 10 further comprising the step of embossing the non-pigmented layer.

14. The method of claim 10 further comprising the step of heat embossing the laminated wipe.

15. The method of claim 10 wherein the wherein the non-pigmented layer and the pigmented layer is selected from spunlace, meltblown or coform.

16. The method of claim 10 wherein the laminated wipe has a vertical wicking capacity of at least about 0.6 g/cc as measured by the Vertical Wicking Capacity Test.

17. The method of claim 10 wherein the laminated wipe has a vertical wicking distance rate of at least about 6 mm in one minute, as measured by the Vertical Wicking Distance Test.

18. The method of claim 10 wherein the laminated wipe has a vertical wicking capacity of at least about 0.12 mm/sec as measured by the Vertical Wicking Distance Test.

19. The method of claim 10 wherein neither the non-pigmented layer nor the pigmented layer is a polymeric film or film-like material.
